(19) United States
(12) Patent Application Publication
(10) Pub. No.: US 2004/0176562 A1
(43) Pub. Date: Sep. 9, 2004

(54) Process for preparing low-odor and storage-stable monomer-containing polyisocyanurates based on isophorone diisocyanate

(75) Inventors: Stephan Kohlstruk, Duelmen (DE); Manfred Kreczinski, Herne (DE); Rainer Elm, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/792,864

(22) Filed: Mar. 5, 2004

(30) Foreign Application Priority Data
Mar. 5, 2003 (DE) 103 09 432.6

(51) Int. Cl. C08G 73/00

(52) U.S. Cl. 528/71

(57) ABSTRACT

Process for preparing low-odor and storage-stable monomer-containing polyisocyanurates from isophorone diisocyanate, in which the partial trimerization is carried out over a period of from 2 minutes to 30 minutes in the presence of from 0.05 to 1.5% by weight, based on the weight of the diisocyanate, of a catalyst of the formula

[R—NX₃]^{m⊕}·mY^{⊖}

where Y⁻ is a carboxylate anion having 4-8 carbon atoms, R is a β-hydroxyalkyl group having 2-6 carbon atoms and X is an alkylene group having from 2 to 3 carbon atoms and the three radicals X together with a shared nitrogen atom which may be partially β-hydroxyalkylated and the quaternary nitrogen form a tricyclic ring which may have an OH group in the α, β, or γ position relative to the nitrogen and m is from 1.0 to 2.0, wherein the trimerization is carried out continuously in a tube reactor, in particular a reaction coil, in a temperature range of 20-120° C., and a pressure range from 0.5 to 5 bar and the catalyst is subsequently thermally deactivated at 100-160° C.

### BACKGROUND OF THE INVENTION

### FIELD OF THE INVENTION

The present invention relates to a process for preparing low-odor and storage stable monomer-containing polyisocyanurates based on isophorone diisocyanate.

### BACKGROUND OF THE INVENTION

Polyisocyanurates are polyisocyanate adducts which are valuable components for producing high-quality coatings having good mechanical properties and resistance to light and weathering. In addition, polyisocyanurates based on isophorone diisocyanate (IPDI) are used as raw material for PUR-based elastomer applications (PUR=polyurethane). It can be desirable to use the IPDI-based polyisocyanurate, also referred to as IPDI trimer, in a monomer-containing form.

Polyisocyanurates are in principle obtained by catalytic trimerization of suitable isocyanates. Suitable isocyanates include, for example, aromatic, cycloaliphatic and aliphatic diisocyanates and higher polyisocyanates. As catalysts for the trimerization, it is possible to use, for example, tertiary amines (U.S. Pat. No. 3,996,223), alkali metal salts of carboxylic acids (CA 2113890; EP 56159), quaternary ammonium salts (EP 798299; EP 524501; U.S. Pat. No. 4,186,255; U.S. Pat. No. 5,258,482; U.S. Pat. No. 4,503,226; U.S. Pat. No. 5,221,743), aminosilanes (EP 197864; U.S. Pat. No. 4,697,014) and quaternary hydroxyalkylammonium salts (EP 17998; U.S. Pat. No. 4,324,879) (the portions of each of which relating to the trimerization if isocyanates is incorporated herein by reference). Depending on the catalyst, the use of various cocatalysts is also possible, e.g. OH-functionalized compounds or Mannich bases derived from secondary amines and aldehydes or ketones.

To carry out the trimerization, the polyisocyanates are allowed to react in the presence of the catalyst, optionally in the presence of solvents and/or auxiliaries, until the desired degree of conversion has been reached. Reference is in this context also made to partial trimerization, since the desired degree of conversion is generally significantly below 100%. The reaction is then stopped by deactivation of the catalyst. This is achieved by addition of a catalyst inhibitor, for example p-toluenesulfonic acid, hydrogen chloride or dibutyl phosphate, which may result in undesirable contamination of the resulting polyisocyanate-containing isocyanurate groups. In the trimerization of isocyanates on an industrial scale, the use of quaternary hydroxyalkylammonium carboxylates as oligomerization catalysts is particularly advantageous. This type of catalyst is thermally labile and allows targeted thermal deactivation, so that it is unnecessary to stop the trimerization after the desired degree of conversion has been reached by addition of potentially quality-reducing inhibitors.

Monomer-containing IPDI trimer which is suitable, for example, for the abovementioned PUR spray applications has an NCO content of from 28 to 32% by weight. The polyisocyanurate is prepared by partial trimerization of IPDI in the presence of one or more suitable catalysts. The catalyst may then either be removed completely from the reaction solution, which can be achieved by short path distillation or thin film distillation, or may be deactivated because the trimer is not storage stable in the presence of residual active catalyst. If the NCO content of the IPDI polyisocyanurate obtained is below the desired level, it can be brought to the desired level without problems by dilution of the solution with monomeric IPDI.

Alkali metal salts of carboxylic acids are not suitable as catalysts for the preparation of monomer-containing IPDI trimer, since they can be removed from the reaction product only with difficulty, if at all. With regard to the available amine-containing catalysts, it has been found that the resulting IPDI trimer solutions generally have a distinctly perceptible odor which is sufficiently pronounced for it still to be noticeable in the final application and be regarded as unpleasant. To eliminate the odor, the reaction solution is, in industrial practice, freed of excess IPDI, odor-imparting components and, if applicable, undesirable catalysts after partial trimerization and catalyst deactivation. This is generally achieved by short path distillation or thin film distillation. The monomer-free solid resin is subsequently converted into the desired, low-odor and monomer-containing IPDI polyisocyanurate by addition of fresh IPDI.

The sequence of partial trimerization/deactivation, monomer removal/purification and subsequent dissolution of the solid resin in the monomer is very complicated. This purification step is time-consuming and costly in conventional processes. A capacity-limiting bottleneck is, in particular, the monomer removal step. A more economical process for preparing low-odor and storage stable monomer-containing polyisocyanurates based on isophorone diisocyanate would, in particular, not necessitate monomer removal.

It is known from EP 1 273 603 that monomer removal can be dispensed with and the use of possibly quality-reducing inhibitors can be avoided when the trimerization of IPDI is carried out batchwise or continuously (cascade of vessels or combination of a cascade of vessels and a tube reactor) in the presence of specific catalysts. However, a disadvantage of the process is the relatively high catalyst requirement and the associated catalyst costs. In addition, the reactivity of the end product of the known process toward the OH-functional reactants used in the production of PUR coatings and PUR-based elastomers is high. A reduced reactivity of the monomer-containing polyisocyanurate would be desirable, since it gives the processor greater latitude in respect of the optimal matching of the processing time to the requirements of the respective application.

It is therefore an object of the present invention to develop a continuous process for preparing IPDI-based low-odor and storage-stable monomer-containing polyisocyanurates which does not have the abovementioned disadvantages of the prior art.

### DETAILED DESCRIPTION OF THE INVENTION

The invention accordingly provides a process for preparing low-odor and storage stable monomer-containing polyisocyanurates from isophorone diisocyanate, in which the partial trimerization is carried out over a period of from 2 minutes to 30 minutes in the presence of 0.05-1.5% by weight, based on the weight of the diisocyanate, of a catalyst of the formula

[R—NX₃]^{m⊕}·mY^{⊖}

where Y⁻ is a carboxylate anion having from 4 to 8 carbon atoms, R is β-hydroxyalkyl group having 2-6 carbon atoms and X is an alkylene group having from 2 to 3 carbon atoms and the three radicals X together with a shared nitrogen atom which may be partially β-hydroxyalkylated and the quaternary nitrogen form a tricyclic ring which may have an OH group in the a, A, or y position relative to the nitrogen and m is from 1.0 to 2.0, wherein the trimerization is carried out continuously in a tube reactor, in particular a reaction coil, in a temperature range from 20 to 120° C., preferably from 40 to 110° C., particularly preferably from 55 to 95° C., and a pressure range from 0.5 to 5 bar, preferably from 0.5 to 2 bar, particularly preferably from 0.9 to 1.5 bar, and the catalyst is subsequently thermally deactivated at 100-160° C. Removal of monomer is not required. Monomer-containing means that the polyisocyanurate contains an amount of an unpolymerized monomer such as IPDI.

In principle, isocyanates suitable for the trimerization can be prepared by a variety of methods (Annalen der Chemie 562 (1949), p. 75 ff. incorporated herein by reference). In particular, the preparation by phosgenation of organic polyamines to form the corresponding polycarbamoyl chlorides and their thermal dissociation into organic polyisocyanates and hydrogen chloride has been found to be useful in industry. As an alternative, organic polyisocyanates can also be prepared without the use of phosgene, i.e., by phosgene-free processes. According to EP-A-126 299 (U.S. Pat. No. 4,596,678), EP-A-126 300 (U.S. Pat. No. 4,596,679) and EP-A-355 443 (U.S. Pat. No. 5,087,739) (each of which is incorporated herein by reference), (cyclo) aliphatic diisocyanates such as 1-isocyanato-3-isocyanatomethyl-3,5,5-trimethylcyclohexane (isophorone diisocyanate or IPDI) can, for example, be obtained by reacting the parent (cyclo)aliphatic diamines with urea and alcohols to form (cyclo) aliphatic biscarbamic esters and their thermal dissociation into the corresponding diisocyanates and alcohols.

In the process of the invention for preparing low-odor and storage-stable monomer-containing polyisocyanurates based on isophorone diisocyanate, the synthetic route by which the IPDI is prepared is immaterial. However, it should be pointed out that the amount of catalyst necessary to achieve a desired NCO content depends, inter alia, on the quality of the raw material. Experience has shown that an increasing content of hydrolyzable chlorine compounds in the IPDI makes an increase in the amount of catalyst necessary. It appears that the hydrolyzable chlorine may have an inhibiting effect on the catalyst.

The preparation according to the invention of the low-odor storage stable monomer-containing polyisocyanurates based on isophorone diisocyanate by partial trimerization is carried out continuously in a tube reactor, in particular in a reaction coil. The catalyst is used in a low concentration of from 0.05 to 1.5%, preferably 0.1 to 1.0%, more preferably 0.2 to 0.5%, by weight. The precise amount can readily be determined experimentally and is dependent on the catalyst, on the intended degree of conversion and on the quality of the IPDI used.

The partial trimerization can be carried out over a period of from 2 minutes to 30 minutes. The product comprises monomeric IPDI, trimeric IPDI isocyanurate and higher oligomers having an isocyanurate structure. Small amounts of compounds having a uretdione structure may also be found as secondary components. Compounds of this type have been described in the literature.

According to the invention, the catalyst is used in an amount of 0.05-1.5% by weight, based on the weight of the isophorone diisocyanate used. The catalyst can readily be obtained by reaction of the three basic building blocks: tricyclic diamine, carboxylic acid and oxirane. The preparation can be carried out in the presence or absence of a solvent. It is usual to use low molecular weight alcohols such as methanol or ethylene glycol as solvent. Tricyclic diamines include, for example, diazabicyclo[2.2.2]octane. Suitable carboxylic acids include, for example, acetic acid, hexanoic acid and 2-ethylhexanoic acid. Oxiranes include, for example, propylene oxide, butylene oxide and 1,2-epoxyhexane. The molar ratios of the three basic building blocks for preparing the catalysts used according to the invention can be varied. Depending on the ratio of the basic building blocks, catalysts having at least one quaternary nitrogen atom in the molecule are obtained. As the examples show, catalysts which have two quaternary nitrogen atoms may also be used.

The process of the invention is carried out at temperatures of from 20° C. to 120° C., preferably from 40° C. to 110° C. and particularly preferably from 55 to 95° C.

According to the invention, the partial trimerization of the isophorone diisocyanate is carried out continuously in a tube reactor, in a preferred embodiment in a reaction coil.

Two streams, viz. isophorone diisocyanate and the appropriate catalyst, are passed continuously through a mechanical mixer. In the mixer, the catalyst is homogenized in the isophorone diisocyanate at temperatures of from 20° C. to 40° C. The mixture subsequently flows through a tube reactor, in a preferred embodiment a reaction coil, in which the trimerization takes place at temperatures of from 20° C. to 120° C., preferably from 55° C. to 95° C. The tube reactor, in a preferred embodiment a reaction coil, may have a plurality of zones whose temperature can be controlled. These allow optimum process control both in respect of the conversion and in respect of the temperature profile of the reaction at any time. After the desired degree of conversion has been reached, the reaction mixture is thermally quenched at from 100 to 160° C., which results in destruction of the catalyst. The resulting reaction mixture is storage stable and low in odor.

The catalyst can be used in pure form, but to allow more precise metering and optimal mixing of the catalyst it can be advantageous to dissolve the catalyst in a suitable solvent. Suitable solvents are in principle those in which the catalyst is readily soluble, e.g. water, low molecular weight alcohols such as methanol or ethylene glycol or low molecular weight organic acids such as acetic acid or hexanoic acid.

The low-odor and storage stable monomer-containing polyisocyanurates based on isophorone diisocyanate prepared according to the invention are useful intermediates for polyurethane coatings, polyurethane and polyurea moldings such as those produced, for example, by the RIM (Reaction Injection Molding) process, for polyurethane spray applications or for polyurethane-based automobile window seals. In these applications, they can also be used in a form capped with blocking agents. Suitable blocking agents are, for example, lactams such as ε-caprolactam, oximes such as methyl ethyl ketoxime or butanone oxime, triazoles such as 1H-1,2,4-triazole, readily enolizable compounds such as acetoacetic esters or acetylacetone or else malonic acid derivatives such as malonic diesters.

### EXAMPLES

Preparation of Catalysts

Catalyst 1

70% by weight of a mixture of propylene oxide, 2-ethylhexanoic acid and diazabicyclo[2.2.2]octane (molar ratio=1:1:1) were stirred in the presence of 30% by weight of ethylene glycol for 3 days at room temperature.

Catalyst 2

60% by weight of a mixture of propylene oxide, 2-ethylhexanoic acid and diazabicyclo[2.2.2]octane (molar ratio=1.25:1.25:1.12) were stirred in the presence of 40% by weight of ethylene glycol for 3 days at room temperature.

### Trimerization Experiments: Examples 1-2 and Comparative Examples 1-2

The reactions were carried out under an N₂ atmosphere.

### EXAMPLES

A.1. Trimerization of IPDI Using Catalyst 1

24.0 g/h (0.27% by weight) of catalyst 1 were metered continuously into a continuous IPDI stream of 9,000 g/h at 35° C. The temperature in the mixer was 39° C. A temperature profile of 61° C.-72° C.-86° C.-80° C. was established in the downstream reaction coil. The thermal deactivation of the reaction solution took place at 100° C. The reaction solution produced in this way had an NCO content of 29.0% by weight. It was allowed to cool to room temperature. The NCO content of the low-odor reaction product remained stable even after storage (7 d, 20-30° C.). The residence time in the tube reactor was 135 seconds.

The reaction product was brought to an NCO content of 29.6% by weight by means of fresh IPDI. The gel time of a combination of the polyisocyanate with an OH resin (Capa 3050/Oxyester T 1136 7:3, NCO/OH 1:1) was determined as 85 hours.

A.2. Trimerization of IPDI Using Catalyst 2

28.0 g/h (0.30% by weight) of catalyst 2 were metered continuously into a continuous IPDI stream of 9,200 g/h at 39° C. The temperature in the mixer was 42° C. A temperature profile of 66° C.-89° C.-89° C.-83° C. was established in the downstream reaction coil. The thermal deactivation of the reaction solution took place at 110° C. The reaction solution produced in this way had an NCO content of 28.8% by weight. It was allowed to cool to room temperature. The NCO content of the low-odor reaction product remained stable even after storage (7 d, 20-30° C.). The residence time in the tube reactor was 130 seconds.

The reaction product was brought to an NCO content of 29.6% by weight by means of fresh IPDI. The gel time of a combination of the polyisocyanate with an OH resin (Capa 3050/Oxyester T 1136 7:3, NCO/OH 1:1) was determined as 83 hours.

### Comparative Examples

B.1. Trimerization of IPDI Using Catalyst 1 (Batch Reactor)

50 kg of IPDI were placed in a stirred vessel and heated to 70° C. 0.4% by weight of catalyst 1 were subsequently metered in stepwise over a period of about 25 minutes at such a rate that the temperature of the reaction solution did not exceed 90° C. The reaction solution prepared in this way had an NCO content of 29.1% by weight. It was allowed to cool to room temperature. The NCO content of the low-odor reaction product remained stable even after storage (7 d, 20-30° C.).

The reaction product was brought to an NCO content of 29.6% by weight by means of fresh IPDI. The gel time of a combination of the polyisocyanate with an OH resin (Capa 3050/Oxyester T 1136 7:3, NCO/OH 1:1) was determined as 72 hours.

B.2. Trimerization of IPDI Using Catalyst 2 (Batch Reactor)

50 kg of IPDI were placed in a stirred vessel and heated to 70° C. 0.43% by weight of catalyst 2 was subsequently metered in stepwise over a period of about 30 minutes at such a rate that the temperature of the reaction solution did not exceed 90° C. The reaction solution prepared in this way had an NCO content of 29.0% by weight. It was allowed to cool to room temperature. The NCO content of the low-odor reaction product remained stable even after storage (7 d, 20-30° C.).

The reaction product was brought to an NCO content of 29.6% by weight by means of fresh IPDI. The gel time of a combination of the polyisocyanate with an OH resin (Capa 3050/Oxyester T 1136 7:3, NCO/OH 1:1) was determined as 71 hours.

TABLE 1
Trimerizations of IPDI (examples A.1. to A.2. and
comparative examples B.1. to B.2.)

| | | | | | |
|---|---|---|---|---|---|
| | | | Amount | NCO | |
| | | | of cat. | content | |
| | | | ‘% by | ‘% by | |
| Expt. | Category | Catalyst | weight’ | weight’ | Remarks |

| | | | | | |
|---|---|---|---|---|---|
| A.1. | Example | Catalyst 1 | 0.27 | 29.0 | storage-stable, low in |
| | | | | | odor, gel time 85 h |
| A.2. | Example | Catalyst 2 | 0.30 | 28.8 | storage-stable low in |
| | | | | | odor, gel time 83 h |
| B.1. | Comparative | Catalyst 1 | 0.40 | 29.1 | storage-stable low in |
| | Example | | | | odor, gel time 72 h |
| B.2. | Comparative | Catalyst 2 | 0.43 | 29.0 | storage-stable low in |
| | Example | | | | odor, gel time 71 h |

German application 10309432.6 filed on Mar. 5, 2003 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1. A process comprising:
at least partially trimerizing isophorone diisocyanate to form a monomer-containing polyisocyanurate, wherein the partial trimerization is carried out over a period of from 2 minutes to 30 minutes in the presence of 0.05-1.5% by weight, based on the weight of the diisocyanate, of a catalyst of formula
[R—NX₃]^{m⊕}·mY^{⊖}
where Y⁻ is a carboxylate anion having 4 to 8 carbon atoms, R is a β-hydroxyalkyl group having 2 to 6 carbon atoms and X is an alkylene group having from 2 to 3 carbon atoms and the three X together with a shared nitrogen atom which may be partially β-hydroxyalkylated and the quaternary nitrogen form a tricyclic ring which may have an OH group in the α, β, or γ position relative to the nitrogen, and m is from 1.0 to 2.0, wherein the trimerization is carried out continuously in a tube reactor in a temperature range of 20 to 120° C., and a pressure range from 0.5 to 5 bar and,
subsequently thermally deactivating the catalyst at 100 to 160° C.

2. The process as claimed in claim 1, wherein the isophorone diisocyanate is obtained from a phosgene process or a phosgene-free process.

3. The process as claimed in claim 1, wherein the monomer-containing polyisocyanurate has an NCO content of from 22 to 34% by weight.

4. The process as claimed in claim 1, wherein the trimerization is carried out at a temperature of from 40 to 110° C.

5. The process as claimed in claim 1, wherein the trimerization is carried out at a temperature of from 55 to 95° C.

6. The process as claimed in claim 1, wherein the trimerization is carried out at a pressure of from 0.5 to 2 bar.

7. The process as claimed in claim 6, wherein the trimerization is carried out at a pressure of from 0.9 to 1.5 bar.

8. The process as claimed in claim 1, wherein unreacted isophorone diisocyanate is not removed.

9. The process as claimed in claim 1, wherein the trimerization is carried out continuously in a reaction coil.

10. The process as claimed in claim 1, further comprising
adding additional isophorone diisocyanate after deactivating the catalyst.

11. The process as claimed in claim 1, wherein the catalyst is obtained by reacting a mixture of propyleneoxide, 2-ethylhexanoic acid and diazabicyclo[2.2.2]octane.

12. The process as claimed in claim 1, wherein the catalyst is obtained by reacting propyleneoxide, 2-ethyhexanoic acid and diazabicyclo[2.2.2]octane in a molar ratio of 1:1:1 to 1.25:1.25:1.12.

13. A monomer-containing polyisocyanurate obtained by the process as claimed in claim 1.

14. A polyisocyanurate comprising the catalyst of claim 1 and isophorone diisocyanate.

15. A composition comprising isophorone diisocyanate and the catalyst of claim 1.

16. The process as claimed in claim 1, wherein the trimerization is carried out in a low molecular weight alcohol.

17. The process as claimed in claim 1, wherein the catalyst is derived from a tricyclic amine, a carboxylic acid selected from the group consisting of acetic acid, hexanoic acid, and 2-ethylhexanoic acid, and the oxirane is selected from the group consisting of propyleneoxide, butyleneoxide and 1,2-epoxyhexane.

18. The process as claimed in claim 1, wherein the trimerization is carried out in the absence of a solvent.
